(19) United States
(12) Patent Application Publication
(10) Pub. No.: US 2013/0179786 A1
(43) Pub. Date: Jul. 11, 2013

(54) SYSTEM FOR RECOMMENDING MOVIE FILMS AND OTHER ENTERTAINMENT OPTIONS

(71) Applicant: Film Fresh, Inc., Los Angeles, CA (US)

(72) Inventor: Richard Lewis Bolton, JR., Los Angeles, CA (US)

(73) Assignee: FILM FRESH, INC., Los Angeles, CA (US)

(21) Appl. No.: 13/736,050

(22) Filed: Jan. 7, 2013

Related U.S. Application Data
(60) Provisional application No. 61/584,202, filed on Jan. 6, 2012.

(51) Int. Cl. G06F 3/0482

(52) U.S. Cl. CPC G06F 3/0482
USPC 715/719

(57) ABSTRACT

Described herein is a online, network-based system that recommends to a user media items for the user's enjoyment, based upon the user's emotional goal, i.e., the user's goal with respect to the user's emotions and thoughts after viewing, listening or reading the media item. The system is used on and in conjunction with a computer, such as a desk top or laptop device, or a tablet device, smart phones, and other internet-enabled devices. The system may be used to recommend a film based on the user's mood at the time the user is using the system, or based on what the user anticipates his or her mood to be at the time the film will be viewed. However, preferably the system is used to recommend a film based on the emotional state that the user would like to create for him or herself and/or for others who will be viewing the film with the user (such as to raise the film viewer(s)' spirits, to battle the forces of evil, to understand life, etc.).

### CROSS-REFERENCE TO RELATED APPLICATIONS

This application claims priority to the pending U.S. provisional application entitled “System for Recommending Movie Films and Other Entertainment Options”, Ser. No. 61/584,202, filed Jan. 6, 2012, the entire disclosure of which is herein incorporated by reference.

### BACKGROUND

Entertainment, such as movies and television shows, are currently typically available online, such as via downloading and streaming to various internet-enabled devices, such as personal computers, tablets, smart phones, and so-called smart (internet ready) televisions, as well other devices such as Roku players, certain I-Pod or MP3 players, hand-held game devices, game devices such as Xbox, and the like. Retailers of online entertainment typically provide graphical interfaces displaying their entertainment options, e.g., listings of the titles of media items available (movie, television program, audio recording, books, magazines, podcasts, etc.), as well as other biographical information regarding each media item's title, and providing a mechanism by which potential customers can view, purchase and/or rent the media item thereby presenting potential customers who purchase and/or rent the media item, with graphical menus listing the available entertainment options

### SUMMARY

Described herein is an online, network-based system that recommends to a user media items for the user's enjoyment, based upon the user's emotional goal, i.e., the user's intended state with respect to the user's emotions and thoughts after viewing, listening or reading the media item. The system is used on and in conjunction with a computer, such as a desk top or laptop device, or tablet devices, smart phones, and other internet-enabled devices. The system may be used to recommend a film based on the user's mood at the time the user is using the system, or based on what the user anticipates his or her mood to be at the time the film will be viewed. However, preferably the system is used to recommend a film based on the emotional state that the user would like to create for him or herself and/or for others who will be viewing the film with the user (such as to raise the film viewer(s)' spirits, to battle the forces of evil, to understand life, etc.).

### BRIEF DESCRIPTION OF DRAWINGS

FIG. 1 is a flowchart illustrating the system and method of an embodiment of the invention wherein the media item is a movie film.

FIG. 2 is a screen shot of the second window of the graphical user interface of an embodiment of the system of the invention.

FIG. 3 is a screen shot of the third window of the graphical user interface of an embodiment of the system of the invention.

FIG. 4 is a close-up of a portion of a screen shot of the third window of the graphical user interface of an embodiment of the system of the invention.

FIG. 5 is a screen shot of the fourth window of the graphical user interface of an embodiment of the system of the invention.

FIG. 6 is a screen shot of a window displayed as a result of the user engaging clicking or touching “MORE LIKE THIS” in the window shown in FIG. 4.

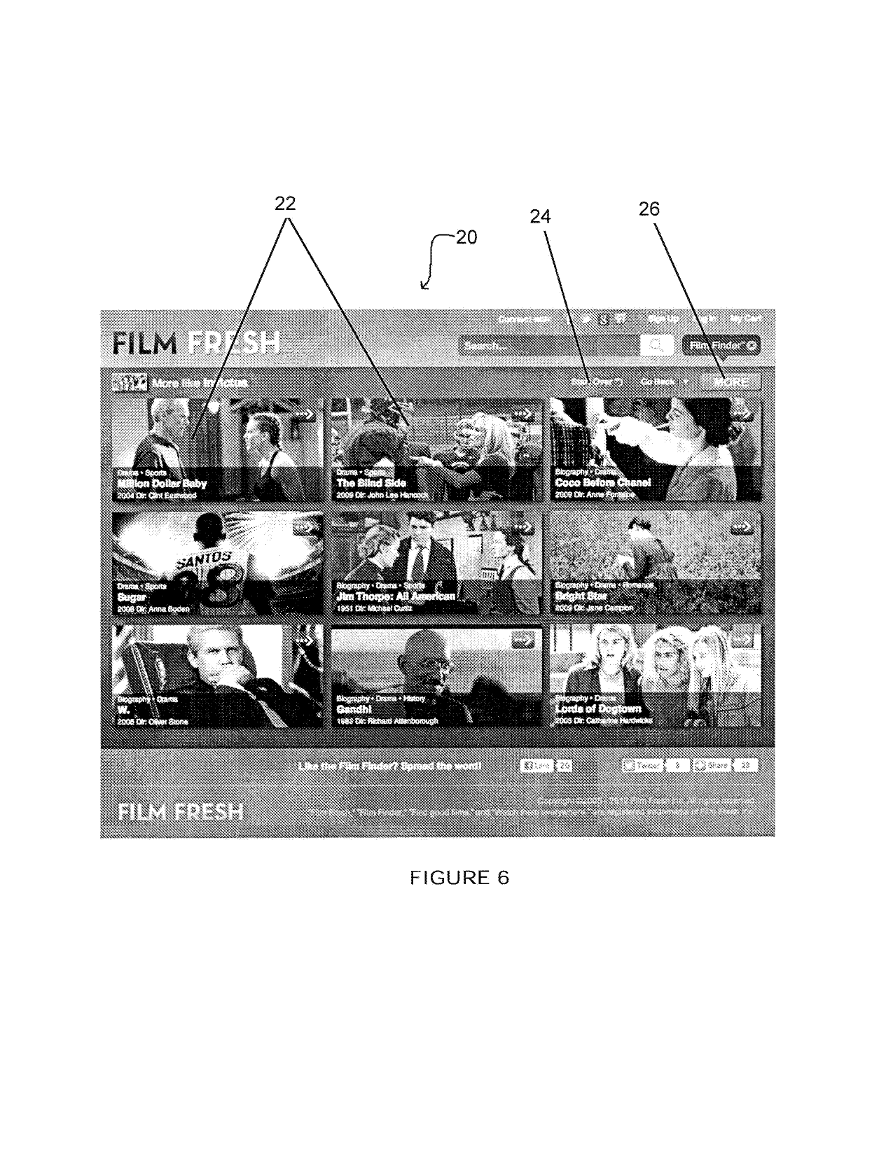

See FIG. 6 for an illustration of a screen that appears with additional set of films when “MORE LIKE THIS” is selected

### DETAILED DESCRIPTION

Described herein is a network-based content recommendation system that recommends to a user media items for the user's enjoyment, based upon the user's wish to achieve a certain emotional state of mind, i.e., the user's emotional goal. The system is used on and in conjunction with a device. The term “device” as used herein means any device existing now or developed in the future that a user can use to access a software application and view a media item. Examples of these devices are computers, such as desk top computers and laptops, tablets, smart phones, game consoles, hand-held game consoles, Roku devices, internet-ready televisions and other internet-enabled devices.

The system is particularly useful for recommendations of movie films, but it is also useful for recommending other types of entertainment media items in addition to or instead of movie films. The term “media item” as used herein encompasses any form of entertainment content accessible and viewable by a device. Examples of media items for which the invention may be used include but are not limited to movie films, television programs, videos (such as non-professional videos that a consumer might make, or professional videos on various subjects), music videos, documentaries, audio recordings, games, books (fiction and non-fiction), periodicals, manuscripts, etc. The invention will be described herein primarily in terms of an embodiment in which it is used for recommending movie films.

The system provides recommendations regarding media items, offered in a fashion that dynamically allows a user to find a media item that fits the user's emotional goal. The term “emotional goal” as used herein refers to the user's desired emotional state, state of mind and/or outlook as a result of viewing the media item. The system may be used to recommend a media item based on the user's emotional state at the time the user is using the system, or based on what the user anticipates his or her mood to be at the time the media item will be viewed and/or heard (in the case of audio recordings). Preferably, the system is used to recommend a film based on an emotional goal that the user would like to reach for him or herself and/or for others who will be viewing the film with the user (such as to raise the film viewer(s)' spirits, to create a romantic mood, to understand life, etc.).

The term “user” as employed herein is an individual who utilizes the online, network based system of the invention to select a media item or items. While a single “user” is referred to herein, in practice two or more people can co-operatively use the system of the invention by reaching a consensus regarding each selection required by the system.

The term “purchaser” as used herein is defined as a user who buys or rents the media item. The term “purchase” as used herein is defined as the act of paying for the sale or rental of the media item. The term “purchase” also includes situations wherein the user has paid an advance fee, such as a membership fee, to access a catalog of media items and to select and view on a device a limited or unlimited number of media items in that catalog during a specified time period.

Unlike other film recommendation services, users of the system of the invention are not required to rate films, fill out a questionnaire or provide personal information.

Digital technology has expanded exponentially the amount of content available to consumers. Online retailers that provide movies, television and music are able to offer a much larger selection than their brick-and-mortar rivals—thousands of titles just a few clicks away.

Although a physical, brick-and-mortar store typically offers consumers a more limited selection than can be obtained online, brick-and-mortar environments encourage browsing. Browsing typically involves walking through a store, flipping through racks and displays, conversing with the sales staff. Browsing proceeds by both desire and surprise—part shopping, part research, part self-education, part accident.

Heretofore it has not been possible to closely replicate the brick and mortar browsing experience in the online purchasing environment. The object of the present invention is to provide a system for potential purchasers of media items to browse and choose amongst potential media items. Another object of the present invention is to provide a way for the user, the potential purchaser of online media items, to find something new, unexpected and unknown which expands the purchaser's horizon and yet still is consistent with the purchaser's tastes.

To encourage browsing (also known as “personalized content discovery”), online entertainment retailers have developed a handful of automated approaches for recommending alternative offerings of their products. The following approaches are commonly used and keeping track of a customer's purchase history, a potential or actual purchaser's viewing history, content ratings and metadata matching. Retailers such as Amazon use customer purchase histories as the basis for future recommendations. For example, the purchase or rental of a film by a given director will result in the recommendation of other films by the same director, and other films with similar subject matter or genre. Customers are also presented with the purchase decisions made by other similar shoppers: “Customers who purchased this film also purchased . . . ” In a similar fashion, online retailers track which items are viewed by a given customer, regardless of whether these items were purchased or not, with the assumption that viewing behavior eventually leads to purchasing. The recommendation process for viewing history is the same as that for purchase history, i.e., presenting customers with information including the behavior of others, e.g., “customers who viewed this movie also viewed . . . ”

Other entertainment retailers, such as Netflix, attempt to improve the recommendation process by interviewing customers about their likes and dislikes, asking them to rate specific movies. These content-rating based recommendations become more targeted as the retailer learns more about the consumer, that is, as the number of films rated by the consumer grows. There are two key problems with recommendations created by content rating. First, the process requires an extensive time commitment from the consumer, as customers must typically rate dozens of films to provide relevant results. Second, the relevant results are based only on similarity in the actors, genre, directors, etc., providing recommendations on movies that bear similarities with the customer's prior choices.

The prior art recommendation services rely on automatic systems of metadata matching. Each bit of information about a film—its director, actors, genre, country, rating, subject matter, even specific story lines (e.g., boy meets girl, spy defects to another country)—provide opportunities to compare and connect that film to other titles. Other information can also be included in film metadata, as, for example, whether a film is funny, or scary, or an award-winner, or an audience favorite. It is possible within a search process to assign a different weight to every data field, telling the search engine to pay more attention to the name of the director when matching films, or to plot points, or to genre or country. By adjusting the value of each data point, results can be altered significantly, imparting a different flavor to each retailer's recommendations.

The system of the invention approaches the user through his or her emotional goal—not the mood of the film, but the desired emotional goal of the user of the system who will be the viewer of the film ultimately selected by the user.

The system described herein comprises three layers or main steps. These layers or steps together provide a novel and unexpected system for recommending media items to potential purchasers. The system described herein is particularly useful for recommending feature length films (movies), but is also useful for a virtually unlimited number of media items, such as television programs, documentaries, podcasts, music, and books.

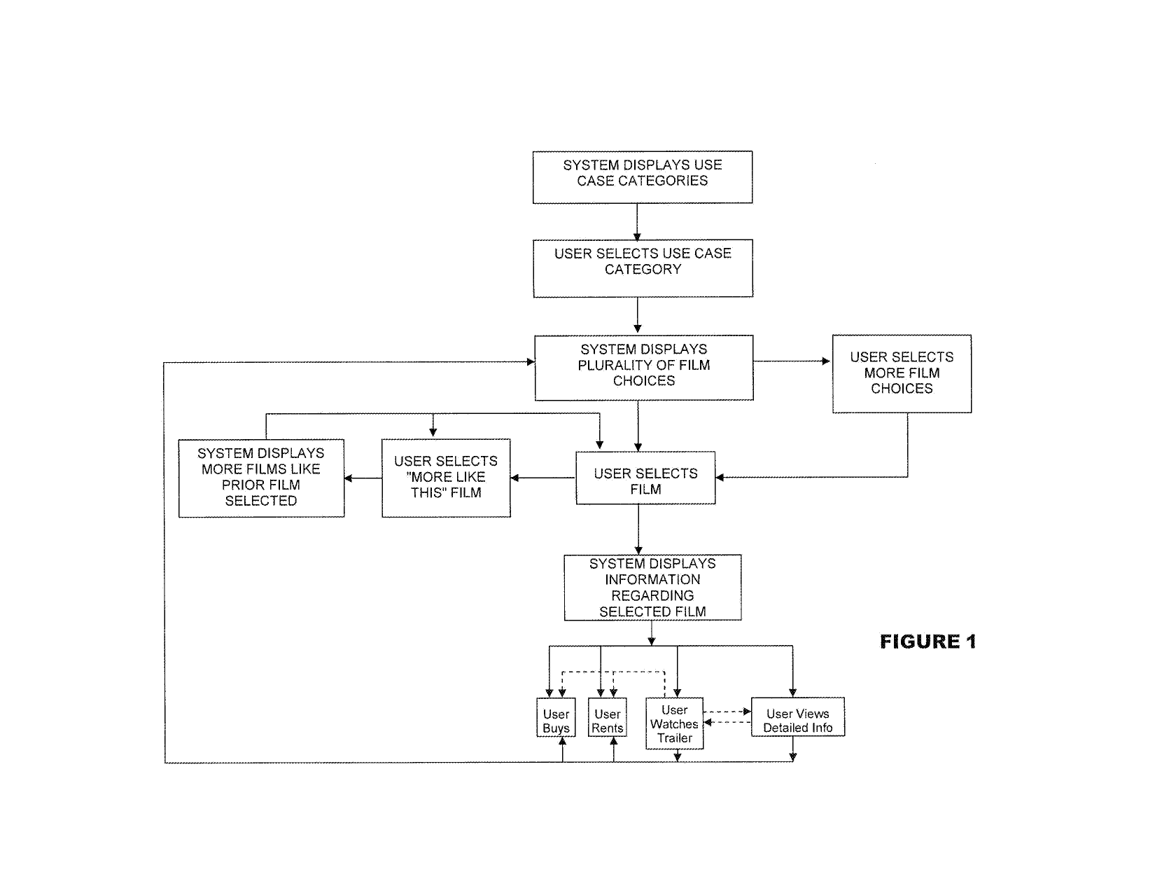

FIG. 1 is a flow chart illustrating, from the perspective of a user of the system, the steps in the method and the functions of the system of an embodiment of the invention, i.e., wherein the media item to be selected is a movie film. This embodiment of the invention comprises a method having the following steps: (a) generating a plurality of use cases; and (b) displaying a graphical user interface on a device, using network based applications, the graphical user interface being configured to allow a user to navigate through a plurality of window types, and wherein the graphical user interface is comprised of three windows.

The system is used as follows:

The user selects from one of several pre-determined emotional goal categories referred to herein as “use cases.” The names of and composition of the use cases are created by the provider of the system prior to presentation via the system. Each use case is not directed to a specific genre, but rather cuts across multiple genres. These categories permit the user to select a category which reflect the user's emotional goal (such as to change one's mood, to be consistent with the user's present mood, to reach an emotional goal of the user for the user and/or those who will be viewing the film, etc.)

Layer One: Customer Use Cases

The first layer of the system's graphical user interface presents the user with a series of “use cases.” These use cases aim to address the emotional intention of the user—the user's entertainment goal. The user is invited to choose a use case corresponding to a certain theme. The term “mood” as used herein encompasses more than the typical range of human emotions (sad, happy, anxious, frightened, excited, etc.); “mood” as used herein, refers to desired emotional goals and state of mind that the user wishes to be in after the movie is watched.

Customer use cases are formulated by the provider of the system, and then films are selected by the provider to be placed under each customer use case. Thereafter, the multiple films selected for a given use case are sequenced, by placing the film in order of the strongest fit with that use case to the weakest fit with that use case.

The following are non-limiting examples of use cases:

Raise my spirits: Audience goal: A sense of happiness. These films cheer people up and have uplifting themes.

Get edgy. Audience goal: A sense of hipness. These films “push the envelope,” taking risks with subject matter, form and/or character.

Kiss & make up. Audience goal: A sense of resolution. These films feature various forms of conflict that are resolved over the course of the film.

Battle the forces of evil. Audience goal: A sense of victory. These films feature a hero or heroine fighting some sort of pernicious influence.

Kick back. Audience goal: A sense of relaxation. These films are fun, easygoing and require little energy from the viewing audience.

Visit new worlds. Audience goal: A sense of discovery. These films explore unknown or remarkable subject matter, both real and imagined.

Make my heart race. Audience goal: A sense of excitement. These films are exciting to view, raising the adrenaline and pushing viewers to the edge of their seat.

Understand life. Audience goal: A sense of wisdom. These films offer thoughtful meditations on the larger questions of existence.

It should also be noted that these use cases may evolve—new uses cases may be introduced, based on seasonal imperatives, user needs and success analysis of the current use cases, e.g., “Celebrate the holidays,” ‘Visit the past,” “Change my life.” Therefore, the recommendation system described herein encompasses the development and utilization of goal-oriented use cases.

The graphical user interface has three windows. The first window type comprises a tool to allow the user to access a plurality of use cases; this window type is not shown in the drawings.

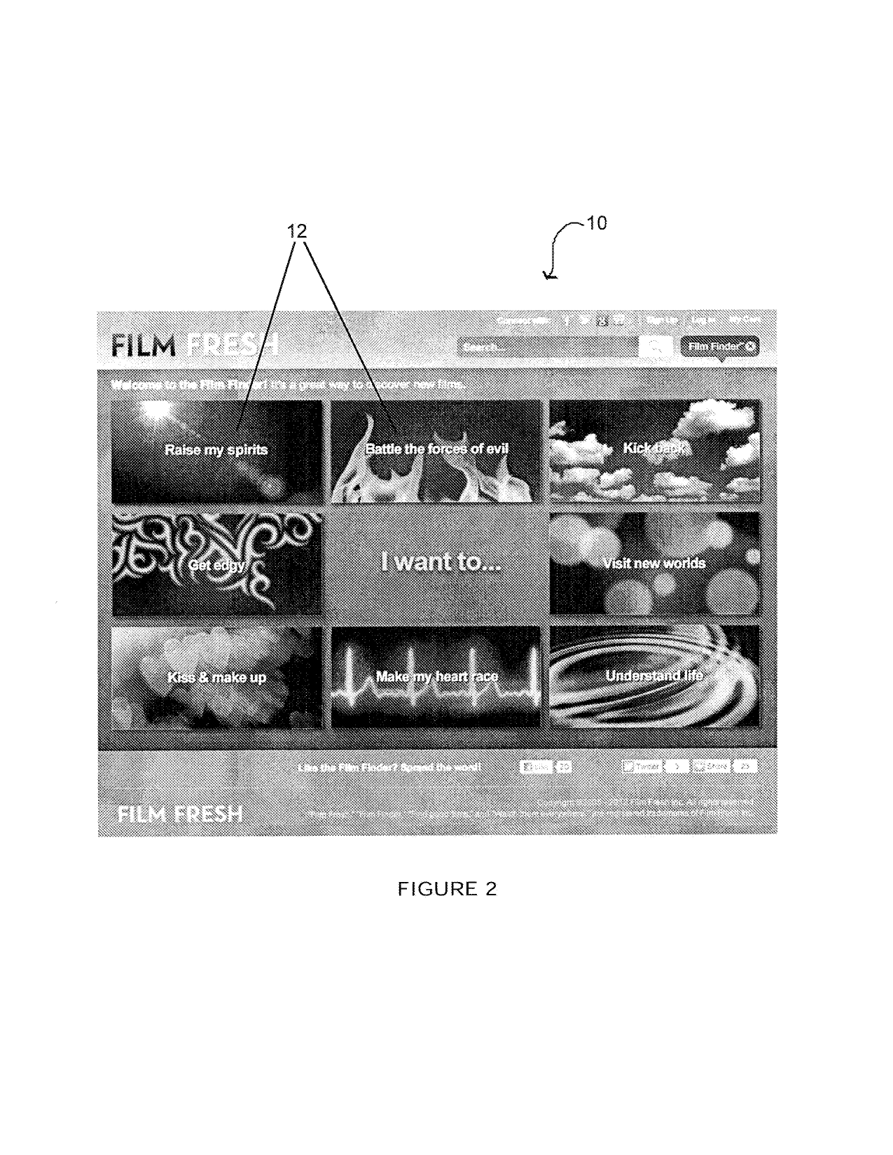

The second window type 10 comprises a display of a plurality of use cases 12, which allows the user to select from among the displayed use cases to choose a selected use case; a screen shot of the second window 10 displaying eight (8) use cases 12 is shown in FIG. 2. However, the second window can have less than or more than eight (8) use cases, but must have at least two (2) use cases.

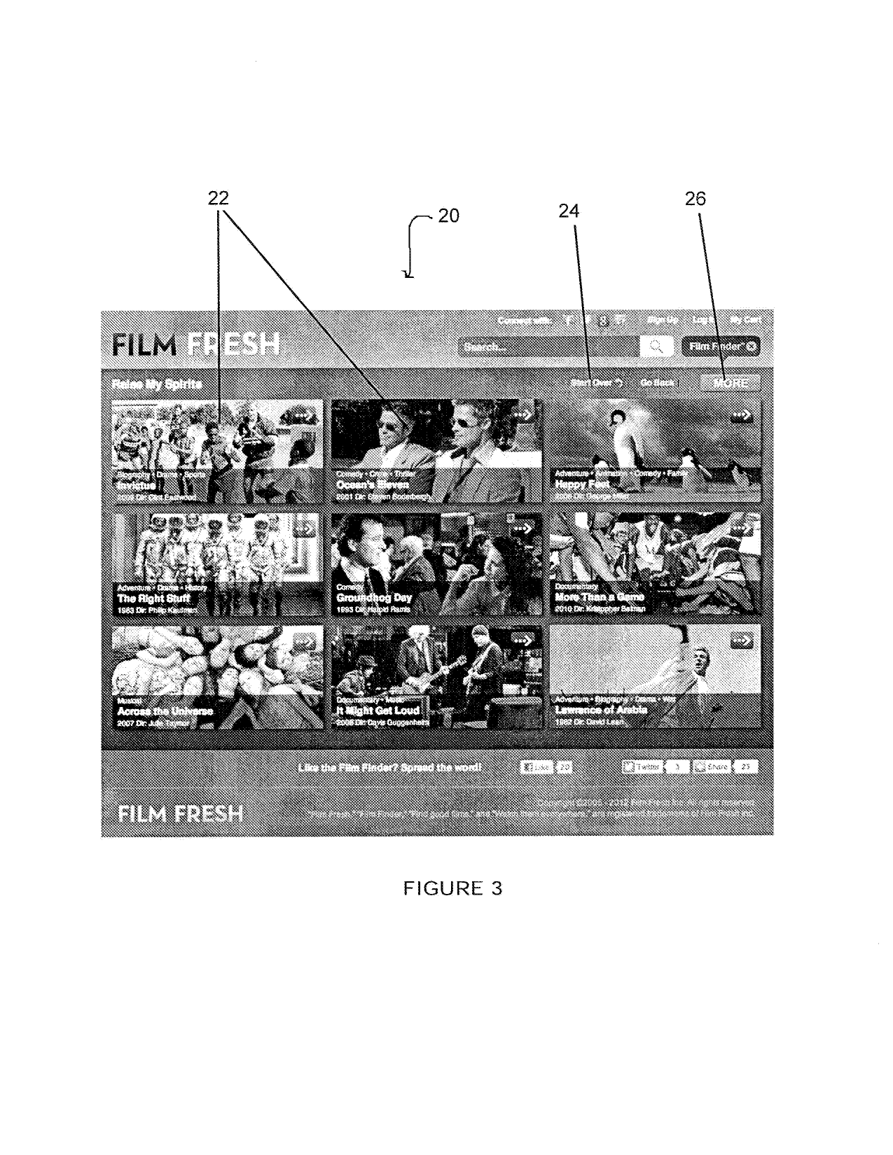

The third window type 20 of the selected use case comprises multiple movie film titles 22 selectable by the user, a means 24 selectable by the user to return to the second window, and a means 26 selectable by the user to display additional movie film titles which are categorized in the selected use case; a screen shot of an exemplary embodiment of the third window 20 is illustrated in FIG. 3 displaying nine (9) film titles 22

FIG. 6 is a screen shot of an exemplary embodiment of a third window type 20 displayed as a result of the user engaging means 26 selectable by the user to display additional movie film titles which are categorized in the selected use case.

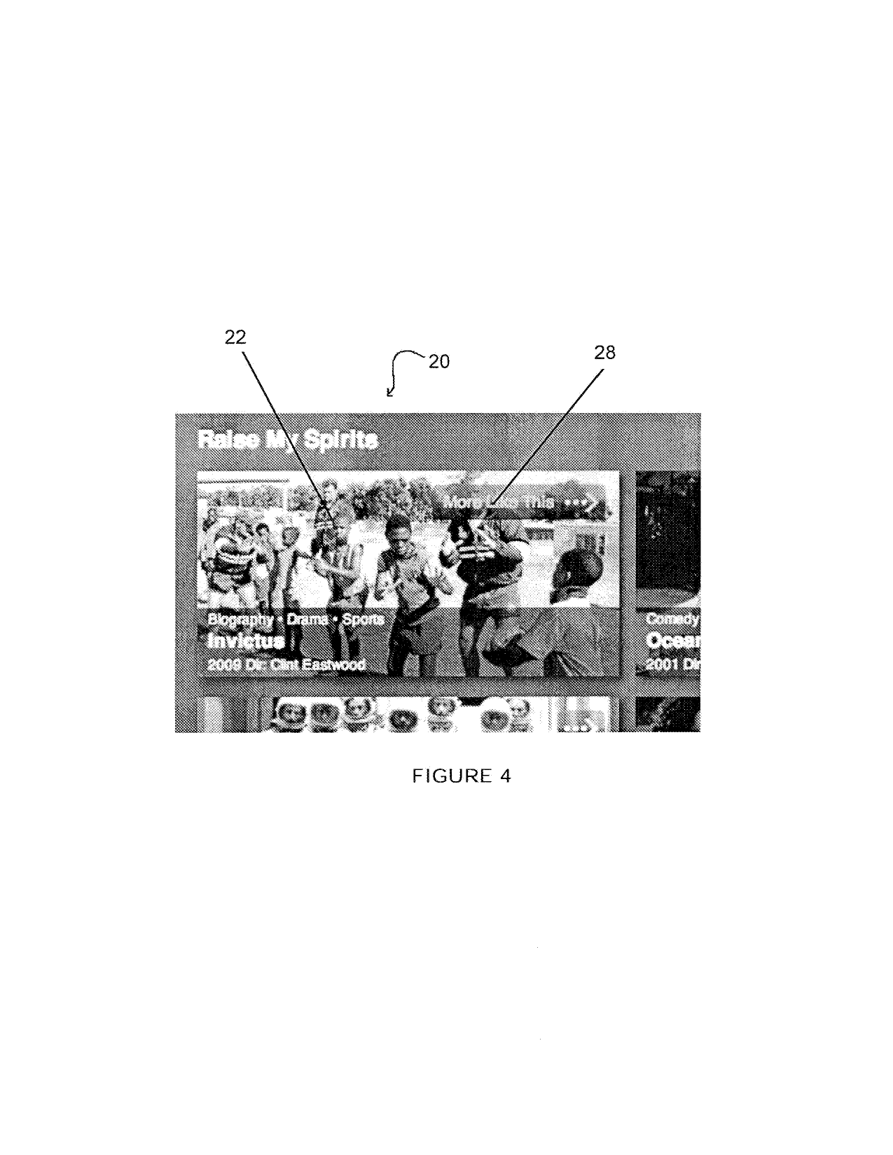

FIG. 4 illustrates a close up view of a portion of a screen shot of an exemplary embodiment of the third window type 20; shown in FIG. 4 is a means 28 found on each film title and selectable by the user to display additional film titles that are similar to that particular film title.

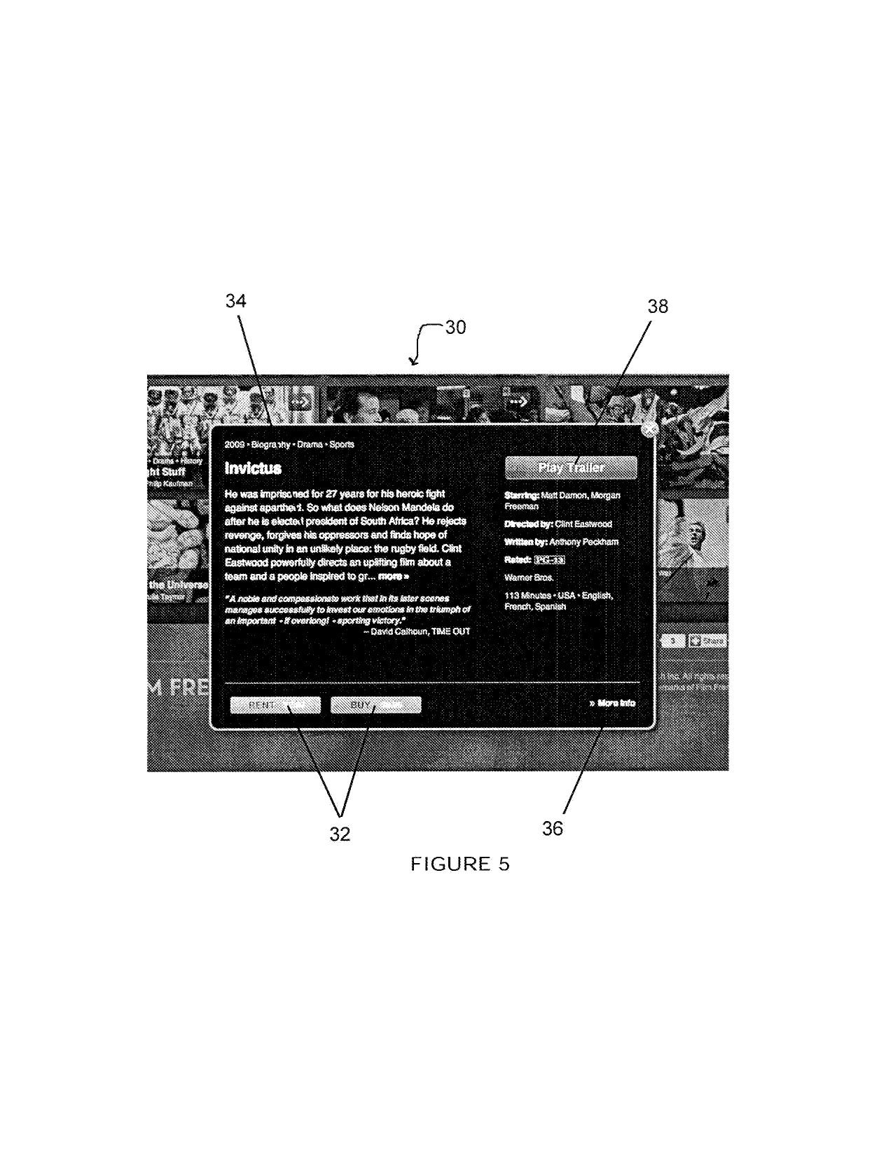

The fourth window type 30 comprises information and means 32 for purchasing a selected movie film, information 34 about the selected movie film, a link 36 to information about the selected movie film, and a link 38 to view a portion (such as a movie trailer) of the selected movie film; a screen shot of an exemplary embodiment of the fourth window type 30 is shown in FIG. 5.

An exemplary embodiment of the graphical user interface on which the pre-determined use case categories are displayed is illustrated in FIG. 2, which is a screen shot of the second window of the interface. In this embodiment, each of the pre-determined categories has its own “box” which may be clicked on with the cursor operated by the user's mouse, or alternatively by touching the screen in devices capable of operation by touch.

When the user has selected one of the above use case categories by “clicking” on or touching the category desired, a further screen pops up, displaying information regarding one or more films for the user to select from. The films presented for each use case are pre-determined. The films to be presented have been selected for each use case by staff members, each of whom is well-versed and trained in the many forms of contemporary cinema. The staff members follow a proprietary selection process, as described herein. The goal of the selection process is to choose a small collection of quality films for each use case that will reveal as much as possible about the taste of the user. Typically, the number of films for each use case falls in the range of nine (9) to twenty-seven (27). In a preferred embodiment of the invention, nine (9) films are selected for each use case, to eventually be presented to the user who selects the particular use case.

The following factors are taken into consideration when pre-selecting films for each use case:

The overall quality of the film or media item is analyzed, by examining the reputation of the film, through examining critics' reviews, film festival awards, audience and professional recommendations, and other “word of mouth” sources, such as social media.

How well the film fits into a particular use case is determined. To determine this, the film's plot is examined, as are reviews that speak to the emotional qualities of a given film.

The box office and marketing profile of the film may be examined as well, although box office “success” is a less significant factor than overall quality.

Finally, the educated personal judgment of the system's provider's staff members is considered.

Once films have been chosen for each use case, they are sequenced within the system. This sequencing has a great deal of influence over the ultimate success of the system. After a user selects a use case within the graphical user interface, the user is shown a finite number of pages of recommended films. The number of pages can range from one page to 50 or greater, and the number of films on each page can range from one to an infinite number. Preferably, the user is shown between one to three pages, with nine films arranged on each page. Each set of films on each page has been carefully selected and sequenced on each page, to provide a number of revealing options. With regard to sequencing of the films, the films are each placed in an order, so that the set of nine films most relevant to the use case are shown to the user first. If the user wishes to view another set of films for that use case, the user requests same via the graphical user interface. In a preferred embodiment, the user makes the selection by clicking on a virtual button or box displayed on the screen with the indicator “MORE” or other similar indication. The sequencing of films is typically predetermined by staff members of the system's provider, in an order positioning of film each set of films,

Each group of selected films on a given page within the use case section of the application represents a variety of film genres, countries of origin, and eras of production. In other words, for a given use case, such as “Kiss and Make Up”, the selection of movies may include comedies, romances, dramas, thrillers, biographies and science fiction works. A given page of films offers the user both familiar and unknown titles, and includes the element of surprise, and will encourage browsing and self-education.

Given the variety of potential choices within a given page in a given use case, even a single browsing selection by the user is revealing, in that the choices made by each user provide information regarding that user's overall taste and predilections as far as films are concerned. Within a single use case, one person may select a superhero movie, whereas another person may select a horror film, still yet another an international drama, and still yet another a comedy. Through session tracking and metadata comparison, the details of these film choices are “remembered” by the system, leading to further film recommendations, as described below.

In another example, in the use case “Battle the forces of evil,” a user will find highly recommended “superhero films” (such as THE DARK KNIGHT RISES), science fiction titles (like BLADE RUNNER, MEN IN BLACK and the classic GHOSTBUSTERS), documentaries (like FOOD INC., about the struggle over nutrition, COOL IT, about the issue of global warming, and RELIGULOUS, about atheism), horror titles (the Hollywood film ZOMBIELAND, the Danish film LET THE RIGHT ONE IN), dramas (THE ROAD, A HISTORY OF VIOLENCE, the Spanish film THE SECRET IN THEIR EYES, the business drama GLENGARRY GLEN ROSS) and so on.

To summarize, the first layer of the system depends upon emotional self-analysis by the user through, first, the choice of a given entertainment goal or “use case,” and second, the browsing of high quality films selected and organized through human curation rather than automation. To counteract the “garbage in, garbage out” approach of the typical content recommendation process, the system introduces unique and highly relevant information into the search process, providing an alternative and corrective to the flaws in fully automated recommendation services.

Which use case or cases that each film falls does not change during an individual user's particular use of the system. However, the films that are present in each use case category at any given time may be changed by the provider of the system (not the user). The system's provider may change the films based upon its curatorial decision-making process. The films may also be changed based upon data regarding multiple users' choices that is gathered over a certain time period or periods, via the use of proprietary computer software. In other words, the software tracks the number of times certain films are chosen by users who are searching for films in a particular mood/intent category, and based upon that data, particular films can be removed or added to that particular category.

When the user selects a use case, in a preferred embodiment information regarding a plurality of (two or more) films is displayed. In a preferred specific embodiment, information regarding each of nine (9) films is displayed, as shown in FIG. 3. FIG. 4 illustrates a close up of the screen as it appears when the cursor is placed over a specific film, wherein “MORE LIKE THIS” pops up. The user can then click or touch “MORE LIKE THIS”, and an additional set of films will appear, as illustrated in FIG. 6.

See FIG. 6 for an illustration of a screen that appears with additional set of films when “MORE LIKE THIS” is selected. The system may be set up so that “MORE LIKE THIS” is an available choice for any number of times. The system may also be set up to permit the user to return to any screen by clicking or touching a certain place on the screen, such as on the “START OVER” icon that is shown in the upper right hand corner of FIGS. 2, 3 and 6.

This information which appears after the user has selected one of the films may be displayed in any manner that permits the user to understand what films are listed. In a preferred embodiment, information regarding each film is set forth within a specific geometric shape, such as a rectangle, which may clicked or touched.

The term “information” regarding the film as used in the preceding paragraph means one or more of the following types of information: title of the film, an image of a scene from the film, the year that the film was released, the director of the film, the rating of the film by the Motion Picture Association of America (e.g., PG-13, R, etc.), and any other identifying information, such as the genre(s) or category(ies) of the film (e.g., drama, action, romance, music, musical, family, war, crime, etc.

The user now has the option to either click or touch on a “button” or word on the screen (such as one marked “MORE”) to display additional films if the initial selection is not appealing to the user.

The user also has the option to either click or touch each film displayed, which causes yet another screen to pop up providing view more detailed information regarding the film, such as a plot summary, quotes from film critics, the company that put out the film (e.g., Sony Pictures), etc. That pop up screen also may provide an option to view a trailer (preview) for that film, and/or provide options to buy and/or rent that film. See FIG. 5 which illustrates a nonlimiting example of information and options that may be shown.

The second layer of the system works as follows.

The data obtained through the use case process is next filtered through conventional filtering software (that has been optimized by the system's provider) as the user continues to browse the films depicted in the system. These subsequent layers including conventional filterings are not proprietary to the provider of this invention, but the various software processes employed subsequently have been tailored by the inventor to optimize results. The provider of the system may continue to revise and refine the conventional filtering software process so that it will operate successfully.

At any point in the browsing process within the use cases, users can elect to branch off, starting a new path that allows them to see “more like this”, by clicking on a virtual button on or near any film shown in the graphical user interface. By clicking on “more like this”, the user is presented with a new set of films that are similar to the film title that may have sparked their interest.

Metadata attached to each individual film is used to determine the potential similar titles. Metadata matching is fairly standard practice in search and recommendation software, with each search engine customizing search results by giving various weights to individual data points. Standard entertainment metadata may be provided by content studios and distributors, or it may be purchased in the open market. These sources of metadata typically include only the most obvious details of a film: director, actors, rating, generic plot summary, and so on. Most mainstream recommendation services focus on these obvious datapoints, to determine “more like this”: search engines will indicate films by the same director, or with the same actors, or in the same genre.

In addition to using the standard metadata described above, the system of the invention relies on data points that are typically not relied on by prior art recommendation search engines. The invention emphasizes data points that are typically not used and/or undervalued by other search engines, such as story lines or plot points, country of origin and language. The invention also adds additional descriptors to each film, i.e., “tags” designed to draw connections between films with similar themes. For example, these tags might include location information (“North Carolina”), subgenre classification (“road film”), plot points (“father/daughter conflict,” “aging”), among others. By using these tags, the system is able to “connect” or associate films and present and recommend films to the user that prior art search engines would have failed to recommend.

The third layer of the system works as follows.

As a user browses using the system, background software tracks the user's path, recording the variety of choices made. Using comparison software developed and owned by a recommendation service called The Filter, this path is compared to similar paths taken by other users, and in this manner, the system of the invention shifts into “predictive” mode, serving up titles viewed by these other, assumedly like-minded users.

Tracking and path comparison takes place without a login, meaning that a user can obtain the benefits of such “crowdsourcing” without having to register, log in, rate films or make purchases. Relevant recommendation surface immediately, based on user interaction with the system of the invention, as the result of carefully selected use cases, curated film selections and a smoothly designed interaction with underlying automated processes.

Additional films are constantly being added to existing use cases, and positioning of individual titles within each page is constantly revised. These additional films comprise newly released films, as well as older films.

Within the automated metadata matching process, the relative weight of the data points used in the process are frequently reevaluated and revised (with more or less emphasis placed on a given data point, e.g., the genre, country of origin, and so on) with the goal of creating more relevant surprises in recommendations for the user.

Optionally, the system may incorporate an additional data layer in the recommendation process, comprising data voluntarily provided by users who log into the system using a social login, i.e., via a social network services such as Facebook or Twitter. It includes relevant information about the content associations created by the user within one of these services (e.g., what the user indicates in Facebook that the user “likes,” who the user's friends are, what the user's friends “like,” etc.), to enhance the recommendation results within the system of the invention.

1. A method for media item selections, comprising:
(a) generating a plurality of use cases; and
(b) using network based applications, displaying a graphical user interface, the graphical user interface being configured to allow a user to navigate through a plurality of window types, comprising:
a first window type comprising a tool to allow the user to access the plurality of use cases;
a second window type comprising the plurality of use cases to allow the user to select from among the use cases to choose a selected use case; and
a third window type of the selected use case comprising a plurality of multiple media item titles selectable by the user; and
a fourth window type comprising a function for purchasing a selected media item.

2. The method of claim 1, wherein the selected media item is accessible on a device.

3. The method of claim 1, the media item is a movie film, a television program, a recording of a theatrical play, a video clip, an audio recording, a book or a periodical.

4. The method of claim 1, wherein in step (b) the third window type further comprises a means selectable by the user to return to the second window, and a means selectable by the user to display additional media item titles.

5. The method of claim 1, wherein in step (b) the fourth window type comprises information about the selected media item, links to information about the selected media item, and a link to view a portion of the selected media item.

6. The method of claim 1, wherein the selected use case corresponds to a user's desired emotional goal.

7. The method of claim 6, wherein the selected use case is selected from the group consisting of Raise My Spirits, Get Edgy, Kiss and Make Up, Battle the Forces of Evil, Kick Back, Visit New Worlds, Make My Heart Race, Understand Life, Celebrate the Holidays, Visit the Past, and Change My Life.

8. The method of claim 7, wherein the media items are movie films.

9. A method for movie film selections, comprising:
(a) generating a plurality of use cases; and
(b) displaying a graphical user interface on a device, using network based applications, the graphical user interface being configured to allow a user to navigate through a plurality of window types, comprising:
a first window type comprising a tool to allow the user to access the plurality of use cases;
a second window type comprising the plurality of use cases to allow the user to select from among the use cases to choose a selected use case;
a third window type of the selected use case comprising multiple movie film titles selectable by the user, a means selectable by the user to return to the second window, and a means selectable by the user to display additional movie film titles;
a fourth window type comprising information for purchasing a selected movie film, information about the selected movie film, links to information about the selected movie film, and a link to view a portion of the selected movie film.

10. A method for selecting a media item, comprising:
(a) accessing on a device a network-based website configured for selecting from among a plurality of use cases, each of the use cases being populated with a list of a plurality of pre-selected media items; and
(b) using a graphical user interface to select at least one media item by at least:
accessing a first window displaying a tool for accessing the plurality of use cases;
selecting the tool;
accessing a second window displaying the plurality of use cases;
selecting at least one use case, the at least one use case being a selected use case;
displaying the selected use case in a third window, the selected use case comprising multiple media item titles;
selecting a media item title;
procuring the media item associated with the media item title.

11. A system for a user to select media items, said system comprising:
(a) a pre-determined plurality of use cases; and
(b) a network based application that displays a graphical user interface, the graphical user interface being configured to allow a user to navigate through a plurality of window types and comprising:
a first window type comprising a tool allowing the user to access the plurality of use cases;
a second window type displaying the plurality of use cases selectable by the user;
a third window type of the selected use case comprising a plurality of multiple media item titles selectable by the user; and
a fourth window type comprising a function for purchasing a selected media item.
